(19) United States
(12) Patent Application Publication
(10) Pub. No.: US 2017/0221504 A1
(43) Pub. Date: Aug. 3, 2017

(54) Photorealistic CGI Generated Character

(71) Applicant: Charles Rinker, Wake Forest, NC (US)

(72) Inventor: Charles Rinker, Wake Forest, NC (US)

(21) Appl. No.: 15/011,580

(22) Filed: Jan. 31, 2016

(51) Int. Cl. G10L 21/10; G06T 15/50; G06T 13/40; G06T 17/20; G06T 19/20

(52) U.S. Cl. CPC G10L 21/10; G06T 17/20; G06T 19/20; G06T 13/40; G06T 15/50

(57) ABSTRACT

This document presents an apparatus and method for creating and displaying a three dimensional CGI character. The 3D CGT character is created as a digital file that is displayed on a silhouette that has an outline of the character created. The top portion of the display silhouette is transparent upon which the 3D CGI character is displayed by a holographic projector. The bottom half of the display silhouette is opaque and conceals the CPU and projector components. The entire silhouette performs as a stand-alone display unit that may be placed in any location a user requires.

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

Computer generated characters are a standby of films, cartoons, movies, and other interactive video displays. Renderings of such computer generated characters may be seen on computer, television, mobile device, and other screens, but holographic, three dimensional characters are not as freely available due to the more expensive equipment required to display a three dimensional character.

Holographic projectors and display systems exist that permit the creation and display of three dimensional characters. However, the creation of such characters often requires a fully equipped video production studio each time a change or generation of a new character is necessary. Additionally, the display requirements of a holographic system often require a large space to accommodate the projection equipment.

### BRIEF DESCRIPTION OF THE DRAWINGS

Certain illustrative embodiments illustrating organization and method of operation, together with objects and advantages may be best understood by reference to the detailed description that follows taken in conjunction with the accompanying drawings in which:

FIG. 1 is a front view of the display apparatus for a 3D CGI character consistent with certain embodiments of the present invention.

FIG. 2 is a view of the rear portion of the display apparatus consistent with certain embodiments of the present invention.

FIG. 3 is a view of the 3D character projection in operation consistent with certain embodiments of the present invention.

FIG. 4 is a flow diagram of the creation of a 3D holographic display character consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

In an embodiment, PRSONAS leverages advanced computer generated characters to create flexible, photo realistic human and non-human character representations that offer several advantages of video and other media. Advance computer generated characters permit complete cosmetic customization based on client requirements including hair color, eye color, skin color, wardrobe, etc., and an ability for single PRSONAS computer generated character to speak literally any language and the ability to change at will simply by updating the spoken voice. Remote content updates are possible without requiring any updates to the physical structure of the PRSONAS unit, and there is no need for expensive (or repeated) video productions to capture initial messaging or to update existing messaging.

In an exemplary embodiment, a PRSONAS CGI character is created through a multistep pipeline process. In addition to the multistep pipeline process of character creation, the system also keeps the silhouette of the CGI character fixed to permit the character to remain centered in the silhouette. Remaining centered in the silhouette retains an illusion of a character having mass within the silhouette. The system also maintains “lighting masks” and “color masks” to keep an even light and even color when being projected in an ultra-short throw holographic projection system, as used in this system. Generating CGI characters is accomplished by completing the following key milestones.

The first step in the pipeline to create a CGI character is modeling. Modeling is the creation (or modification from existing template character) of a 3d mesh forming the structure of the character. In an exemplary embodiment, the CGI character is only modeled from the waist up. The portion of the CGI character from the waist down is printed on the acrylic surface of the display portion. Only the front half facing the camera is modeled to optimize speed and to create fluid animation even on moderate to low end computer hardware.

The next step in the pipeline to create a CGI character is Texturing. Texturing is the process of applying virtual materials including skin tones, clothing and any texture or shader that may be used to create the look of a solid object. A shader is an algorithm used to render the appearance of a solid surface programmatically, providing the ability for realistic physics including stretching and folding. The utilization of shaders assists in the illusion of photorealistic image for the CGI character when active in the display.

The next step in the pipeline to create a CGI character is rigging. Rigging is the process of attaching a virtual skeleton like structure to the mesh created above. The virtual skeleton allows the animators to more easily move and pose the mesh structure through the manipulation of “joints” and “positions” without the need to move individual vertices used to create the mesh. Each vertex (point) in the mesh is weighted against the bone structure of the skeleton to give realistic movement in relationship to the skeleton.

The next step in the pipeline to create a CGI character is Lip Synchronization (Lip Sync). Lip sync is an advanced animation process similar to the Rigging step, but may incorporate other advanced animation rigging structures to provide the extremely sensitive control needed to create realistic facial expressions and movement for synchronization to the spoken voice over.

The next step in the pipeline to create a CGI character is lighting. Lighting is the process of positioning virtual lighting and effects into the above items to create a realistic “scene” capable of being rendered. The goal is to mimic realistic environmental lighting so the character appears to be physically present in the real world environment in which it is placed.

The next step in the pipeline to create a CGI character is rendering. Rendering is the process of using light simulations, ray tracing and other industry rendering technologies to turn the above CGI character development process into a completed image.

The process defined in these steps creates an output of a digital file containing all elements required to recreate the completed CGI character. The digital file is referred to as a ‘character scene’. This ‘character scene’ is then fed into a delivery system.

The delivery of the CGI imagery into the physical world utilizes the hardware integration between the display hardware setup and the ‘character scene.’ The ‘character scene’ derived from the creation process is fed into 3 Dimensional (3D) real-time rendering software running on a CPU/render hardware. The render hardware sends a digital video output to the projector contained in the system chassis. The projector provides the rendered image to an acrylic silhouette that is constructed to match the exact outline of the projected CGI character image previously defined. The image is projected onto a film adhered to the back of the acrylic silhouette.

On the front surface of the acrylic silhouette, a printed opaque image of the bottom half of the CGI character is attached as a solid, unchanging portion of the CGI display. The illusion, when viewed form the front of the unit creates a life size, complete image of the CGI character presented in a holographic silhouette display, while obscuring or completely hiding the chassis that encloses all of the supporting hardware and software of the holographic display unit.

In a non-limiting embodiment, the system and method presents a system for computer generated image (CGI) character generation and display, having a display silhouette device, a software module for creating a CGI character for projection onto the display silhouette device, and where the projection is delivered as a holographic projection onto the rear surface of the display silhouette device. The display silhouette device having the exact outline of a CGI character to be displayed on the display silhouette device, and the display silhouette device is manufactured of an acrylic material; further comprising a transparent film adhered to the back surface of the acrylic material.

In the exemplary embodiment, the upper portion of the display silhouette device is transparent and the lower portion of the display silhouette device is opaque. The display silhouette device is a unit that also includes an equipment chassis into which are installed a CPU and rendering hardware component into which is installed 3D real-time rendering software, and a 3D holographic projector component. The holographic projector may be an ultra-short throw holographic projector to perform the projection of the CGI character. The display silhouette device, equipment chassis, and 3D holographic projector component comprise a stand-alone display device having a physical space requirement small enough to permit the stand-alone display device to be installed and operate in the space usually reserved for a receptionist in any office or venue.

In this embodiment, the CGI character creation software module maps voice over and facial video sequences into a three dimensional CGI character completed image. The CGI character creation software module creates a three-dimensional digital video output for projection onto the display silhouette device. Additionally, the system and method have a software module to receive remote content updates for the CGI character and applies the remote content updates to a three-dimensional digital video output to update the projection of the CGI character.

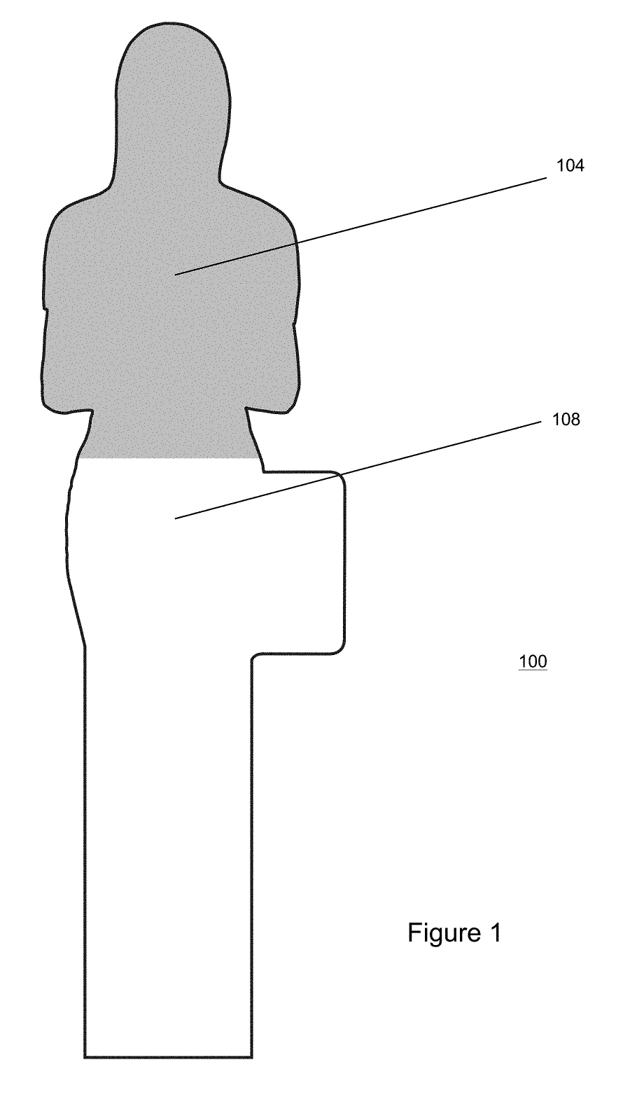

Turning now to FIG. 1, this figure presents a front view of the display apparatus for a 3D CGI character consistent with certain embodiments of the present invention. In an exemplary embodiment, the display apparatus 100 is shaped in the approximate silhouette of a human figure. The upper portion of the display apparatus 104 is composed of a transparent material, such as, in an exemplary embodiment, acrylic, upon which the upper portion of a 3D CGI character may be displayed. The projection sensitive film may be adhered to the back surface of the acrylic transparent material and provides the surface onto which the holographic image of the 3D CGI character is projected. The 3D CGI character may be the upper half of a human character, cartoon character, fictional character, or any other character that may conform to the approximate shape of the silhouette forming the upper portion 104 of the display apparatus 100.

In this embodiment, the lower portion 108 of the display apparatus 100 conforms to the silhouette shape of the lower half of a human character. The lower portion 108 is also composed of an acrylic material. An opaque print of the 3D CGI character is adhered to the front surface of the lower portion 108 of the display apparatus 100. The display of the 3D CGI character on the upper portion 104 of the display apparatus 100 in combination with the opaque print of the bottom of the 3D CGI character on the bottom portion 108 of the display apparatus 100 provides the illusion of a full front view of the 3D CGI character. When viewed from the front of the display apparatus 100 this combination creates a life size complete image of the CGI character.

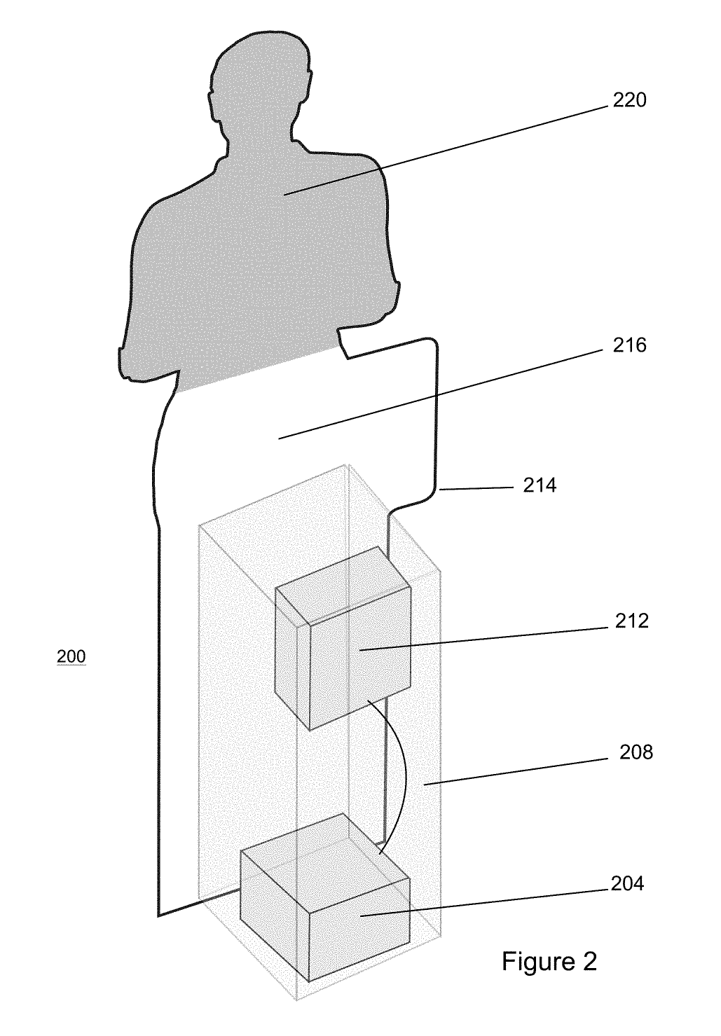

Turning now to FIG. 2, this figure presents a view of the rear portion of the display apparatus consistent with certain embodiments of the present invention. In an exemplary embodiment, the rear view of the display apparatus 200 presents a system chassis 204 into which a central processing unit (CPU) and render hardware 208 and a holographic projector 212 are installed. The 3D character silhouette 214 is attached to the front portion of the system chassis 204 in such a fashion that an opaque portion of the 3D character silhouette 216 completely hides the system chassis 204 and all components installed within the system chassis from viewers standing in front of the 3D character silhouette 214.

The 3D character silhouette 214 is composed of two portions, as previously described. The opaque portion of the 3D character silhouette 216 forms the bottom portion of the 3D character silhouette 214, and a transparent portion of the 3D character silhouette 220 forms the upper portion of the 3D character silhouette 214. The CPU and render hardware 208 is electrically connected both to a battery or other external power source (not shown) and to the holographic projector 212. Additionally, the CPU and render hardware 208 has a data connection to the holographic projector 212 to provide the digital character information to be projected onto the upper portion of the 3D character silhouette 214. A digital character and character scene is transmitted over the data connection from the CPU and render hardware 208 to the holographic projector 212. The digital character scene is then projected onto a film that has been installed on the back side of the upper portion of the 3D character silhouette 220.

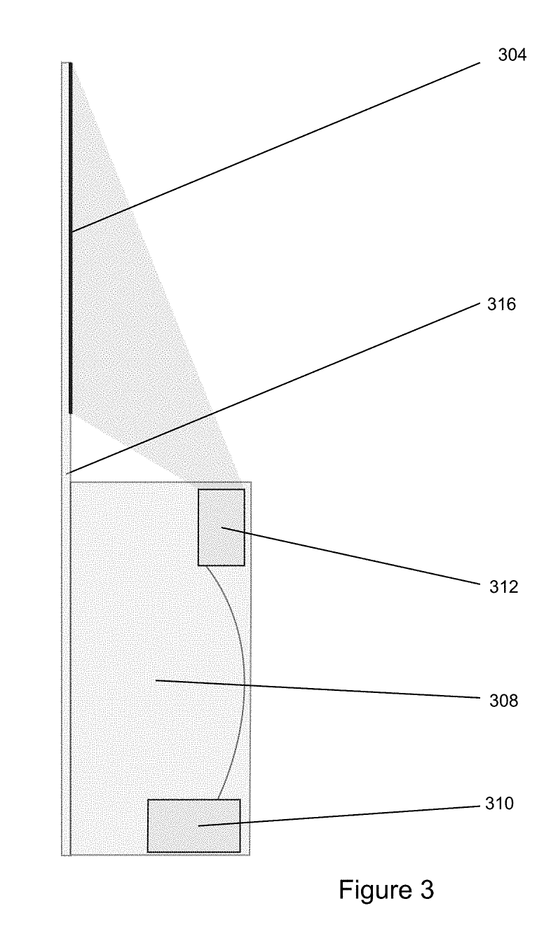

Turning now to FIG. 3, this figure presents a view of the 3D character projection in operation consistent with certain embodiments of the present invention. In an exemplary embodiment, a 3D character projection system and method presents the delivery of generated 3D CGI imagery onto an upper portion of a character silhouette 304. The 3D character projection system may have an equipment chassis 308 into which are installed a CPU and rendering hardware component 310 into which is installed 3D real-time rendering software, and a 3D ultra-short throw projector component 312. Additionally, the equipment chassis 308 also encloses both power and data transmission connections. Power may be provided to the components either through battery or wired connection to an external power source (not shown). Data connections may be made between the CPU and rendering hardware component 310 and the 3D ultra-short throw projector component 312 to transmit 3D character digital files containing character imagery and scenes for display on the upper portion of the character silhouette 304.

Additionally, the character silhouette 304 may have a lower portion that is opaque 316. The opaque portion 316 of the character silhouette 304 is shaped such that it keeps the equipment chassis 308 and all installed components from being seen when the character silhouette 304 is viewed from in front.

When in operation, digital character and character scene data files are transferred from the CPU and rendering hardware component 310 to the 3D ultra-short throw projector component through a data connection between the two components. The digital character and character scene data is formatted for display by the 3D ultra-short throw projector component 312 and projected onto the reverse side of the upper portion of the character silhouette 304. Because the upper portion of the character silhouette 304 is transparent, the characters and character scenes are visible to individuals standing in front of the character silhouette 304. The characters and character scenes appear to be a three-dimensional, holographic representation of the characters and character scenes to viewers positioned in front of the character silhouette 304.

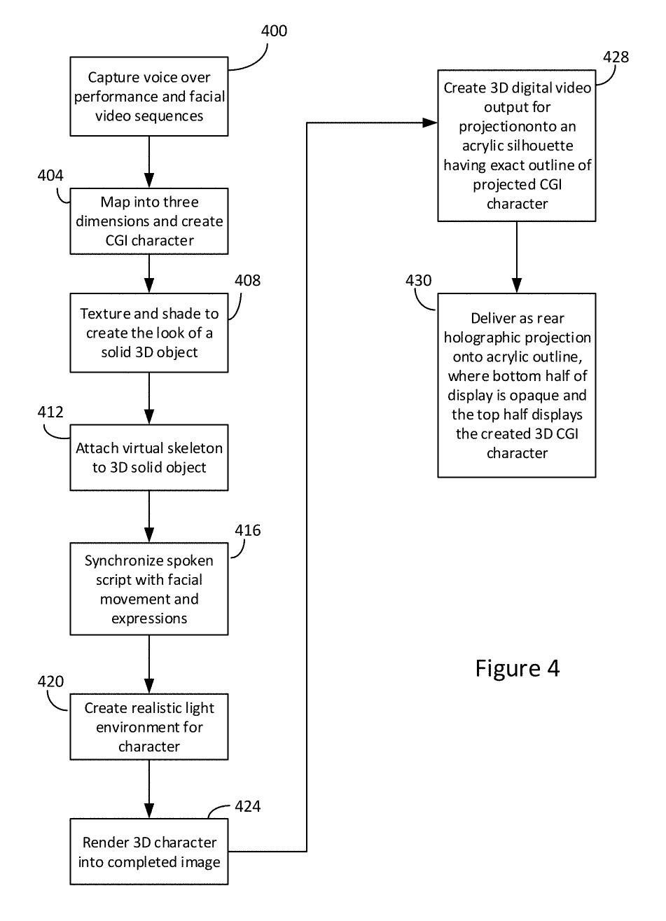

Turning now to FIG. 4, this figure presents a flow diagram of the creation of a 3D holographic display character consistent with certain embodiments of the present invention. In an exemplary embodiment, the creation of a 3D CGI character for transmission and display on a 3D holographic display apparatus begins at 400 with the capture of a voice over performance of a written script. The capture includes the capture of facial video sequences during the voice over performance. In an exemplary embodiment, to optimize speed of the video capture and creating fluid animation even on moderate to low end computer hardware, the video capture is performed for the front portion of a performer and only from the front side. At 404, the captured performance sequences are mapped to a 3D mesh to create a 3D CGI character.

In this exemplary embodiment, texture and shading are added at 408 to create the look of a solid object for the 3D CGI character created from the video capture. Texture and shading includes adding skin tones, clothing, hair, and additional data from one or more shaders to complete the appearance of a solid object. Shaders are algorithms that are used to render the appearance of a solid surface programmatically to provide the ability for the 3D CGI character to appear to obey realistic physical limitations on movement, such as stretching and folding. Shaders assist in the creation of the illusion of a photo realistic image for each 3D CGI character. At 412, a rigging process step is performed to attach a virtual skeleton-like structure to mesh previously created. This rigging permits animators to more easily move and pose the mesh structure through the manipulation of “joints” and “positions” without the need to move individual vertices that were used to create the mesh as a whole.

At 416, a lip synchronization step is performed to synchronize the spoken script with facial movement and expressions. The lip synchronization step may incorporate additional advanced animation rigging structures to provide the extremely sensitive control needed to create realistic facial expressions and movement for synchronization to the spoken text. At 420, virtual lighting effects are added to create a realistic “scene” capable of being rendered. Lighting effects are added to mimic realistic environment lighting such that the 3D character appears to be physically present in the real world environment into which the display apparatus is placed. At 424, the created 3D character is rendered through the action of light simulations, ray tracing and additional rendering methods to create the completed image file for the crated 3D character.

In this exemplary embodiment, at 428 the system creates a 3D digital video output. The 3D digital video is transmitted from the CPU/rendering apparatus to the 3D ultra-short throw projector apparatus. The 3D digital video file is projected onto an acrylic silhouette having the exact outline of the projected 3D CGI character as represented in the 3D digital video output file. At 430, the 3D CGI character digital video file is delivered as a rear-holographic projection through an ultra-short throw holographic projector onto an acrylic silhouette, where the bottom half of the silhouette is opaque and the top half is transparent, displaying the created 3D CGI character.

While certain illustrative embodiments have been described, it is evident that many alternatives, modifications, permutations and variations will become apparent to those skilled in the art in light of the foregoing description.

1. A system for computer generated image (CGI) character generation and display, comprising:
a display silhouette device having an upper transparent portion;
an equipment chassis containing at least a processor, render hardware, and short-throw holographic projector;
a software module operative in the render hardware to create digital three dimensional character and character scene imagery data formatted for projection onto the transparent portion of the display silhouette device;
the digital three dimensional character and character scene imagery data transmitted from the render hardware to the short-throw holographic projector, where the projection is delivered as a holographic projection onto the rear surface of the display silhouette device.

2. The system of claim 1, further comprising [[a]] the display silhouette device having the exact outline of a CGI character to be displayed on the display silhouette device.

3. The system of claim 1, where the display silhouette device is manufactured of an acrylic material, further comprising a transparent film adhered to the back surface of the acrylic material.

4. The system of claim 3, where the upper portion of the display silhouette device is transparent and the lower portion of the display silhouette device is opaque.

5. The system of claim 1, where the display silhouette device comprises an equipment chassis into which are installed a CPU and rendering hardware component into which is installed 3D real-time rendering software, and a 3D holographic projector component.

6. The system of claim 1, where the CGI character creation software module is operative to map voice over and facial video sequences into a three dimensional CGI character completed image.

7. The system of claim 6, where the CGI character creation software module is operative to create a three-dimensional digital video output for projection onto the display silhouette device.

8. The system of claim 1, further comprising a software module operative in the processor to receive remote content updates for the CGI character and applying the remote content updates to the digital three-dimensional character and character scene imagery data to update the projection of the CGI character.

9. The system of claim 1, further comprising an ultra-short throw holographic projector to perform the projection of the CGI character.

10. The system of claim 5, where the display silhouette device, equipment chassis, and 3D holographic projector component comprise a stand-alone display device having a physical space requirement small enough to permit the stand-alone display device to be installed and operate in the space usually reserved for a receptionist in any office or venue.

11. An apparatus for projecting three-dimensional digital imagery, comprising:
a display silhouette device having an upper transparent portion;
an equipment chassis containing at least a processor, render hardware, and short-throw holographic projector, the processor having a wireless communication capability;
a software module operative in the render hardware to create digital three dimensional character and character scene imagery data formatted for projection onto the transparent portion of the display silhouette device;
the digital three dimensional character and character scene imagery data transmitted from the render hardware to the short-throw holographic projector, where the projection is delivered as a holographic projection onto the rear surface of the display silhouette device.

12. The apparatus of claim 1, further comprising [[a]] the display silhouette device having the exact outline of a CGI character to be displayed on the display silhouette device.

13. The apparatus of claim 11, where the display silhouette device is manufactured of an acrylic material, further comprising a transparent film adhered to the back surface of the acrylic material.

14. The apparatus of claim 13, where the upper portion of the display silhouette device is transparent and the lower portion of the display silhouette device is opaque.

15. The apparatus of claim 11, where the display silhouette device comprises an equipment chassis into which are installed a CPU and rendering hardware component into which is installed 3D real-time rendering software, and a 3D holographic projector component.

16. The apparatus of claim 11, where the CGI character creation software module is operative to map voice over and facial video sequences into a three dimensional CGI character completed image.

17. The apparatus of claim 16, where the CGI character creation software module is operative to create a three-dimensional digital holographic video output for projection onto the display silhouette device.

18. The apparatus of claim 11, further comprising a software module operative in the processor to receive remote content updates for the CGI character and applying the remote content updates to the digital three-dimensional character and character scene imagery data to update the projection of the CGI character.

19. The apparatus of claim 11, further comprising an ultra-short throw holographic projector to perform the projection of the CGI character.

20. The apparatus of claim 15, where the display silhouette device, equipment chassis, and 3D holographic projector component comprise a stand-alone display device having a physical space requirement small enough to permit the stand-alone display device to be installed and operate in the space usually reserved for a receptionist in any office or venue.
